(19) United States
(12) Patent Application Publication
(10) Pub. No.: US 2011/0275236 A1
(43) Pub. Date: Nov. 10, 2011

(54) LATCH RELEASING STRUCTURE OF A CONNECTOR FROM A RECEPTACLE

(75) Inventors: QING-MAN ZHU, Kunshan (CN); XUE-LIANG ZHANG, Kunshan (CN); CHIEN-CHIUNG WANG, New Taipei (TW)

(73) Assignee: HON HAI PRECISION INDUSTRY CO., LTD., New Taipei (TW)

(21) Appl. No.: 13/101,169

(22) Filed: May 5, 2011

(30) Foreign Application Priority Data
May 5, 2010 (CN) 201010162496.4

(51) Int. Cl. H01R 13/62

(52) U.S. Cl. 439/352

(57) ABSTRACT

A connector (200) to be forwardly inserted into a receptacle (300) and latched therein. The connector (200) includes a housing (11, 13) and a latch releasing device (7) having a releasing member. The releasing member has a longitudinal pulling portion (75) extending rearward moveable relative to the housing (11, 13) in a horizontal direction, a raising portion (71) extending forwardly from the pulling portion (75), and a supporting portion (71) having a front end supporting the raising portion (713) and a back end fixed to a top face (133) of the housing (11, 13). The front end rotates about the back end to raise the raising portion (71) in response to a backward pulling movement of the pulling portion (75), thereby unlatching the connector (200) from the receptacle (300).

### BACKGROUND OF THE INVENTION

1. Field of the Invention

The present invention relates to a connector, and particularly, to a latch releasing structure of the connector.

2. Description of Related Art

U.S. Pat. No. 7,204,712, issued to Schwiebert et al. on Apr. 17, 2007, discloses a monolithic bail-delatch mechanism for a module plugged into a cage. The bail-delatch mechanism is a single monolithic unit that includes a living hinge connecting a bail and a delatch clip. The bail may include cantilever hooks for securing the bail against the module in a latched position. The delatch clip may include a spring mechanism having two spring arms for locking the bail-delatch mechanism to the module, and a delatch fork having tines with wedges for releasing a post of the module from a latch tab of the cage.

U.S. Pat. No. 7,281,863, issued to Yamada et al. on Oct. 16, 2007, discloses an improved disconnect structure for small form-factor pluggable (SFP) optical transceiver modules. The disconnect structure uses a slide that travels relative to the module housing over a limited range. The slide has operating pieces which are elastically displaceable to elastically displace a spring plate of the cage in a direction to release the locked state. The slide initially moves relative to the module housing to deflect the spring plate downwardly and release the locked state. When the slide then reaches the end of its range of motion relative to the module housing, further withdrawal of the slide pulls the module housing along with it, removing the module from the cage.

U.S. Pat. No. 7,309,250, issued to Reed et al. on Dec. 18, 2007, discloses a shielded housing of an SFP-style connector which includes a conductive body. The housing includes a pair of engagement tabs that are bent inwardly of the housing at an angle thereto and these tabs engage openings formed in a shell of a plug connector that mates with the SFP-style connector. The tabs rest in the openings and may be released by way of latching mechanism that is part of the plug connector.

An object of present invention is to provide a connector having another kind of latch releasing structure.

### SUMMARY OF THE INVENTION

An object of the present invention is to provide a connector to be forwardly inserted into a receptacle and latched therein. The connector comprises a housing defining a top face and a latch releasing device having a releasing member. The releasing member has a longitudinal pulling portion extending rearward moveable relative to the housing in a horizontal direction, a raising portion extending forwardly from the pulling portion, and a supporting portion having a front end supporting the raising portion and a back end fixed to the top face of the housing. The front end rotates about the back end to rise the raising portion in response to a backward pulling movement of the pulling portion, thereby unlatching the connector from the receptacle.

Other objects, advantages and novel features of the invention will become more apparent from the following detailed description of a preferred embodiment when taken in conjunction with the accompanying drawings.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of a connector and a receptacle according to an embodiment of the present invention;

FIG. 2 is an exploded view of the connector shown in FIG. 1;

FIG. 3 is another perspective view of the connector and the receptacle shown in FIG. 1;

FIG. 4 is an exploded view of the electrical connector and the receptacle shown in FIG. 1;

FIG. 5 is another perspective view of the connector and the receptacle shown in FIG. 1;

FIG. 6 is a cross section view of the connector and the receptacle along a line shown in FIG. 5; and

FIG. 7 is a scaled view of the circled portion shown in FIG. 6.

### DETAILED DESCRIPTION OF THE INVENTION

Reference will now be made to the drawing figures to describe the present invention in detail.

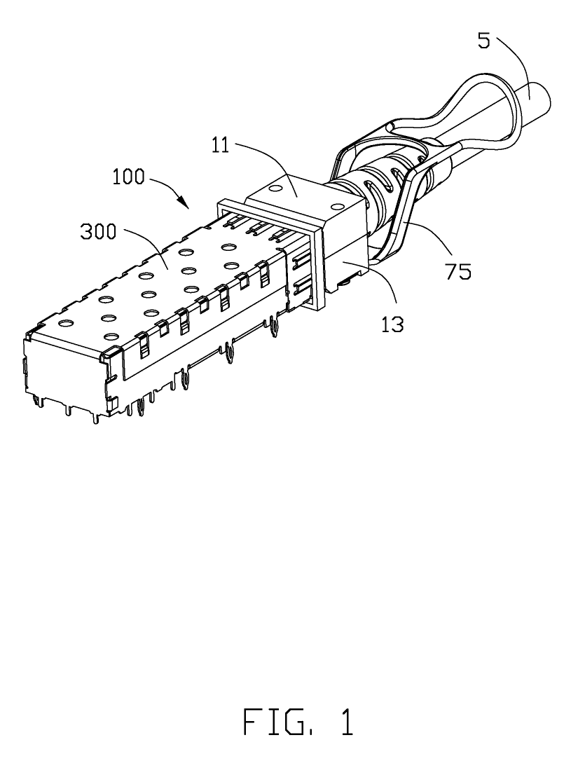

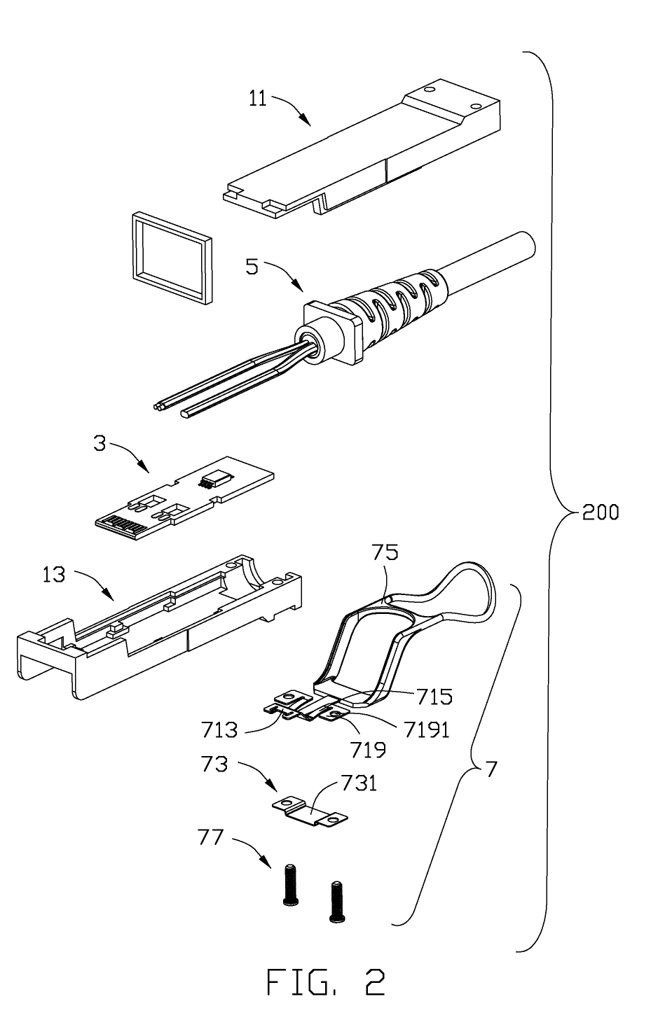

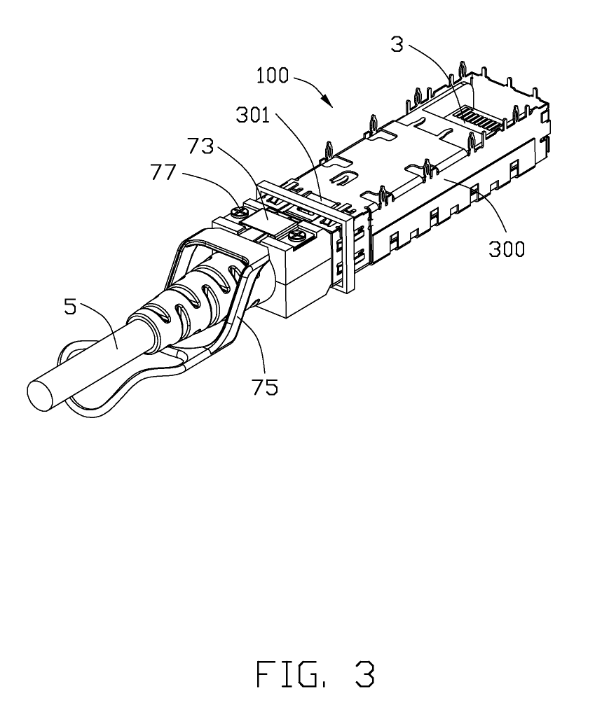

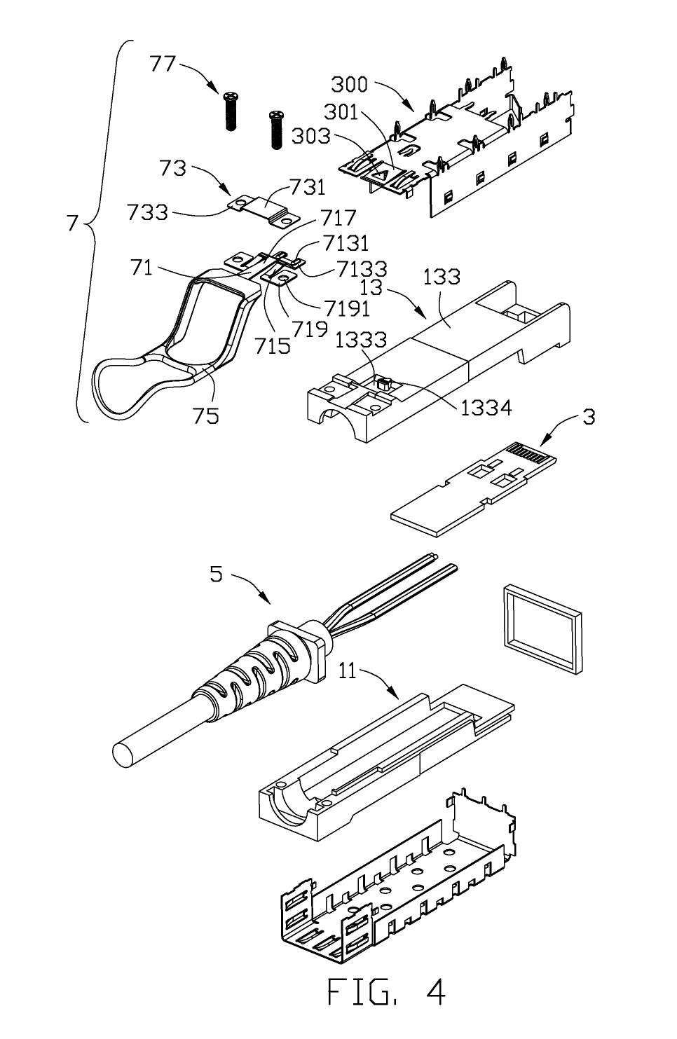

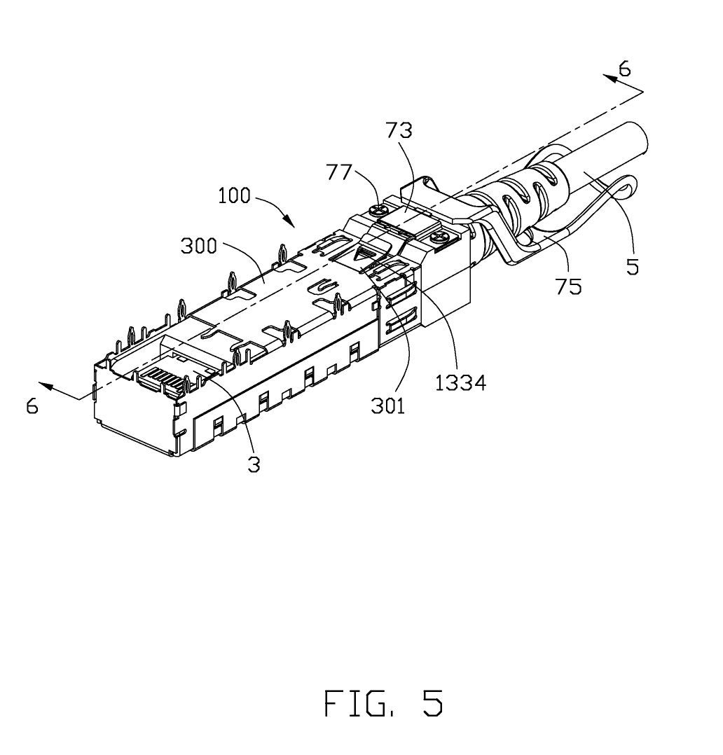

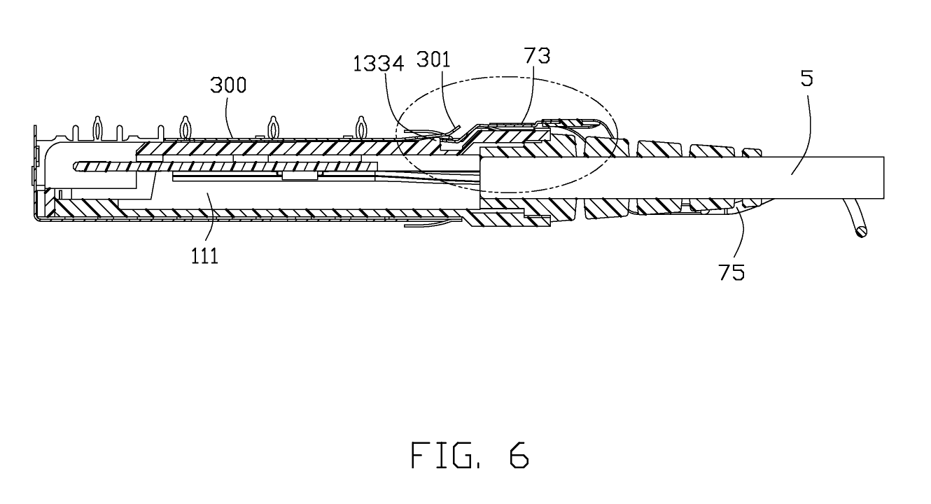

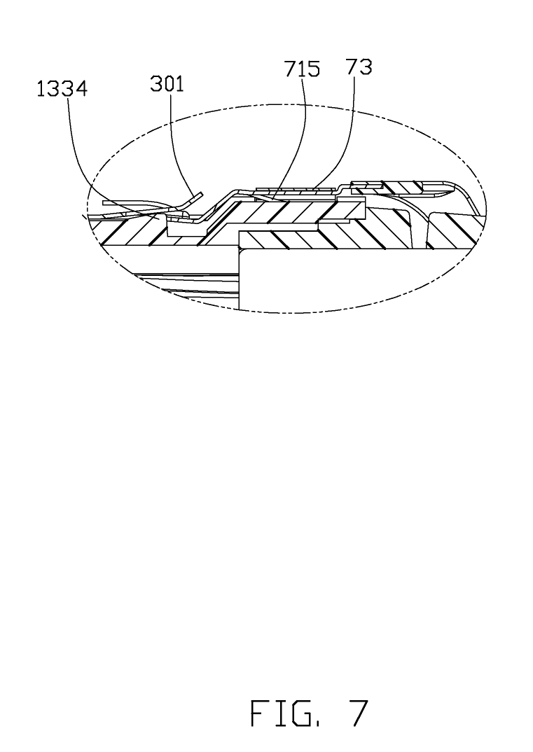

Referring to FIGS. 1-7, a connector 200 and a receptacle 300 for receiving the connector 200 are shown. The connector 200 could be forwardly inserted into a receptacle 300 and latched therein.

The connector 200 includes a housing 11, 13 having a top face, a printed circuit board 3 having a front edge for mating with the receptacle 300, a cable 5 electrically connected the printed circuit board aback the housing 11, 13, and a latch releasing device 7 having a releasing member. The releasing member has a longitudinal pulling portion 75 extending rearward moveable relative to the housing 11, 13 in a horizontal direction, a raising portion 71 extending forwardly from the pulling portion 75, and two supporting portions 715 connecting transversely opposite sides of the raising portion 71. Each of the supporting portions 715 has a back end fixed to the top face 133 of the housing 11, 13 and a front end supporting the raising portion 71. The front end rotates about the back end to raise the raising portion 71 when the pulling portion 75 is pulled backwardly, thereby unlatching the connector 200 from the receptacle 300.

The raising portion 71 and the supporting portion 715 are unitarily formed from a metal sheet. The pulling portion 75 is made of a plastic piece. The raising portion 71 has a front fork portion 713, and a rear portion 717 integrally molded in the plastic piece. The rear end of each supporting portion 715 has a plate portion 719 defining a through hole 7191 therein.

The latch releasing device 7 further includes two bolts 77 mounted through the through holes 7191 and a positioning piece 73 stacked on the plate portions 719 of the releasing member. The bolts 73 fixes the plate portion 719 and the positioning piece 73 to the top face 133 of the housing 11, 13. The positioning piece 73 forms a stop plate 731 above the raising portion 71 for limiting further rising of the raising portion 71.

The housing 11, 13 forms a protrusion 1334 on the top face 133 for mating with an open 303 of a spring tab 301 of the receptacle 300. The front fork portion 713 of the raising portion 71 has two branches 7133 extending to transversely opposite sides of the protrusion 1334 for raising the spring tab 301 of the receptacle 300. The top face 133 of the housing 13 forms a recess 1333 to receive the fork portion. Each of the branches 7133 form a rib 7131 extending longitudinally, which increases the strength of the branches 7133.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A connector to be forwardly inserted into a receptacle, the receptacle forming a spring tab, the spring tab defining an opening to latch a protrusion of the connector, the connector comprising:
a longitudinal housing defining a top face;
a latch releasing device having a releasing member, wherein
the releasing member comprises a longitudinal pulling portion extending rearward moveable relative to the housing in a horizontal direction, a raising portion extending forwardly from the pulling portion, and a supporting portion having a back end fixed to the top face of the housing and a front end supporting the raising portion, the front end rotating about the back end to raise the raising portion in response to a backward pulling movement of the pulling portion, thereby unlatching the connector from the receptacle.

2. A connector as claimed in claim 1, wherein the supporting portion is unitarily formed with the raising portion from a metal sheet.

3. A connector as claimed in claim 2, wherein the pulling portion comprises a plastic piece and the raising portion has a rear end molded in the plastic piece.

4. A connector as claimed in claim 3, wherein the back end of the supporting portion has a plate portion defining a through hole, and the latch releasing device comprises a bolt mounted through the through hole, the bolt fixing the plate portion to the top face of the housing.

5. A connector as claimed in claim 4, wherein there are two supporting portions disposed on transversely opposite sides of the raising portion.

6. A connector as claimed in claim 5, wherein the latch releasing device has a positioning piece stacked on the plate portions of the releasing member and fixed by the bolt.

7. A connector as claimed in claim 6, wherein the positioning piece forms a stop plate above the raising portion for limiting further raising movement of the raising portion.

8. A connector as claimed in claim 1, wherein a front end of the raising portion forms a fork portion having two branches longitudinally extending to transversely opposite sides of the protrusion for raising the spring tab of the receptacle.

9. A connector as claimed in claim 8, wherein the top face of the housing forms a recess to receive the fork portion.

10. A connector as claimed in claim 8, wherein each of the branches forms a rib extending longitudinally.

11. A connector assembly comprising:
a longitudinal housing defining a longitudinal face;
a locking protrusion formed on the longitudinal face;
a cable linked to a rear end of the housing;
a releasing mechanism located behind the locking protrusion and including a locking plate fastened to the longitudinal face, a supporting portion extending forwardly from the locking plate, a raising portion including a front segment linked to the supporting portion and adjacent to the locking protrusion, and a rear segment linked to a pulling portion which is located behind the supporting portion and surrounding the cable; wherein
backward moving of the pulling portion result in outward movement of the front segment for releasing a deflectable locking tab of a corresponding cage in which the housing is received.

12. The connector assembly as claimed in claim 11, wherein the pulling portion defines an operation end which is located on one side of the cable opposite to the face of the housing in a direction perpendicular to an axial direction of the cable.
